(19) United States
(12) Patent Application Publication
(10) Pub. No.: US 2013/0252101 A1
(43) Pub. Date: Sep. 26, 2013

(54) NANOPOROUS SILICON AND LITHIUM ION BATTERY ANODES FORMED THEREFROM

(71) Applicant: UNIVERSITY OF SOUTHERN CALIFORNIA, Los Angeles, CA (US)

(72) Inventors: Chongwu Zhou, Arcadia, CA (US); Mingyuan Ge, Los Angeles, CA (US); Jiepeng Rong, Los Angeles, CA (US); Xin Fang, Los Angeles, CA (US)

(73) Assignee: UNIVERSITY OF SOUTHERN CALIFORNIA, Los Angeles, CA (US)

(21) Appl. No.: 13/831,210

(22) Filed: Mar. 14, 2013

Related U.S. Application Data
(60) Provisional application No. 61/613,892, filed on Mar. 21, 2012.
(60) Provisional application No. 61/613,843, filed on Mar. 21, 2012.
(60) Provisional application No. 61/693,535, filed on Aug. 27, 2012.
(60) Provisional application No. 61/716,044, filed on Oct. 19, 2012.

(51) Int. Cl. H01M 4/04; H01M 4/134

(52) U.S. Cl. CPC H01M 4/049; H01M 4/134
USPC 429/217; 429/218.1; 429/231.8; 429/221; 429/231.5; 216/13; 427/122; 252/182.1

(57) ABSTRACT

An electrode for a lithium ion battery, the electrode including nanoporous silicon structures, each nanoporous silicon structure defining a multiplicity of pores, a binder, and a conductive substrate. The nanoporous silicon structures are mixed with the binder to form a composition, and the composition is adhered to the conductive substrate to form the electrode. The nanoporous silicon may be, for example, nanoporous silicon nanowires or nanoporous silicon formed by etching a silicon wafer, metallurgical grade silicon, silicon nanoparticles, or silicon prepared from silicon precursors in a plasma or chemical vapor deposition process. The nanoporous silicon structures may be coated or combined with a carbon-containing compound, such as reduced graphene oxide. The electrode has a high specific capacity (e.g., above 1000 mAh/g at current rate of 0.4 A/g, above 1000 mAh/g at a current rate of 2.0 A/g, or above 1400 mAh/g at a current rate of 1.0 A/g).

### CROSS-REFERENCE TO RELATED APPLICATIONS

This application claims priority to U.S. App. Ser. No. 61/613,892 entitled “Porous Silicon Nanowires and Lithium Ion Batteries Formed Therefrom” and filed on Mar. 21, 2012; U.S. App. Ser. No. 61/613,843 entitled “Porous Silicon Nanoparticles and Lithium Ion Batteries Formed Therefrom” and filed on Mar. 21, 2012; U.S. App. Ser. No. 61/693,535 entitled “Porous Silicon Nanoparticles and Lithium Ion Batteries Formed Therefrom” and filed on Aug. 27, 2012; and U.S. App. Ser. No. 61/716,044 entitled “Porous Silicon Nanoparticles and Lithium Ion Batteries Formed Therefrom” and filed on Oct. 19, 2012, all of which are incorporated by reference herein in their entirety.

### FIELD OF THE INVENTION

This disclosure relates to nanoporous silicon and lithium ion battery anodes formed therefrom.

### BACKGROUND

Lithium ion batteries (LIBs) have achieved great success as a power supply for portable electronic devices. However, there is a strong desire to expand LIB technology to include batteries for electric vehicles. Tremendous efforts have been devoted in the search for new materials to substitute or partially substitute currently used cathode-electrolyte-anode systems to obtain higher capacity, higher power density, and prolonged cycle life at relatively low production cost.

FIG. 1A depicts lithium-ion battery (LIB) 100 having anode 102 and cathode 104. Anode 102 and cathode 104 are separated by separator 106. Anode 102 includes anode collector 108 and anode material 110 in contact with the anode collector. Cathode 104 includes cathode collector 112 and cathode material 114 in contact with the cathode collector. Electrolyte 116 is in contact with anode material 110 and cathode material 114. Anode collector 108 and cathode collector 112 are electrically coupled via closed external circuit 118. Anode material 110 and cathode material 114 are materials into which, and from which, lithium ions 120 can migrate. During insertion (lithiation or intercalation) lithium ions move into the electrode (anode or cathode) material. During extraction (delithiation or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 1A depict movement of lithium ions through separator 106 during charging and discharging. FIG. 1B depicts device 130 including LIB 100. Device 130 may be, for example, an electric vehicle, an electronic device (e.g., a portable electronic device such as a cellular telephone, a tablet or laptop computer, etc.), or the like.

Typically, LIBs use metal oxide or metal phosphate (e.g., LiMnO₂, LiFePO₄) as a cathode material and graphite as an anode material. Further improvement in terms of capacity may be partly achieved by replacing graphite with new anode materials that can accommodate more lithium. Silicon based lithium alloys are promising materials which can significantly increase the amount of lithium ion intercalation. Theoretically, 1 mole of silicon is able to accommodate 3.75 moles of lithium to form Li₁₅Si₄ at room temperature, corresponding to a capacity of 3600 mAh/g—almost ten times that of graphite (LiC₆, 372 mAh/g). Silicon nanostructures have been studied as anode materials for lithium ion batteries, however the starting materials (e.g., silane and monophenylsilane) are expensive, and the synthetic methods (e.g., pulsed layer deposition, chemical vapor deposition) generally have low yields.

### SUMMARY

In a first general aspect, an electrode for a lithium ion battery includes nanoporous silicon structures, each nanoporous silicon structure defining a multiplicity of pores, a binder, and a conductive substrate, wherein the nanoporous silicon structures are mixed with the binder to form a composition, and the composition is adhered to the conductive substrate to form the electrode.

Implementations of the first general aspect may include one or more of the following features.

In some cases, the nanoporous silicon structures are nanoporous silicon nanowires having a length of 100 μm or less and a diameter of 100 nm or less (e.g., 10 nm or less). In certain cases, the nanoporous silicon structures are nanoporous silicon particles having a mean diameter of 10 μm or less, between 1 μm and 10 μm, between 1 and 100 nm, between 50 and 150 nm, or between 50 and 500 nm. A mean diameter of the pores in the nanoporous silicon structures is in a range between 1 nm and 200 nm. The distance between adjacent pores in the nanoporous silicon structures is in a range between 1 nm and 200 nm.

The nanoporous silicon structures may be nanoporous silicon particles formed from powder silicon nanoparticles, bulk metallurgical grade silicon, or from silicon precursors through a plasma or chemical vapor deposition process. Bulk metallurgical grade silicon is advantageously low cost. Additionally, impurities naturally present in the metallurgical grade silicon reduce or eliminate the need to dope more expensive and pure grades of silicon. The nanoporous silicon structures may be nanoporous silicon nanowires formed by etching a silicon wafer. The nanoporous silicon structures may be doped with boron, arsenic, phosphorus, iron, chromium, aluminum, or a combination thereof.

The electrode may include carbon black mixed with the nanoporous silicon structures and the binder to form the composition. The nanoporous silicon structures may be coated with carbon, reduced graphene oxide, or both (e.g., first coated with carbon, then coated with graphene oxide).

In some cases, the viscosity of the binder is in a range between 100 cP to 2000 cP at room temperature. The binder may be, for example, an alginic acid salt (e.g., a commercially available alginate).

The electrode is an anode for a lithium ion battery. The specific capacity of the electrode exceeds 1000 mAh/g after 100 cycles at a charge/discharge rate of 0.4 A/g. In a second general aspect, a lithium ion battery includes the electrode of the first general aspect.

In a third general aspect, a device includes the lithium ion battery of the second general aspect.

In a fourth general aspect, forming an electrode for a lithium ion battery includes combining nanoporous silicon structures, each nanoporous silicon structure defining a multiplicity of pores, with a binder to form a mixture, and forming the mixture to yield an electrode for a lithium ion battery, wherein the specific capacity of the electrode exceeds 1000 mAh/g after 100 cycles at a charge/discharge rate of 0.4 A/g electrode.

Implementations of the fourth general aspect may include one or more of the following features.

In some cases, solid silicon structures are etched with a first etchant solution including a strong acid and a metal salt to yield the nanoporous silicon structures. The strong acid includes, for example, hydrofluoric acid, ammonium fluoride, nitric acid, sulfuric acid, hydrochloric acid, or a combination thereof. In some cases, the metal salt is silver nitrate. In other cases, the metal salt is iron nitrate, chloroauric acid, copper nitrate, copper chloride, cobalt (III) nitrate, cobalt (III) chloride, or a combination thereof, which have an advantageous low cost advantage.

The etched nanoporous silicon structures may be etched with a second etchant solution including a strong acid and an oxidizing agent. The oxidizing agent may be, for example, hydrogen peroxide. The second etchant solution may include an alcohol may be selected from the group consisting of methanol, ethanol, and propanol.

The solid silicon structures are selected from the group consisting of silicon wafers, silicon nanoparticles, metallurgical grade silicon particles, and silicon particles prepared from silicon precursors in a plasma or chemical vapor deposition process. The metallurgical grade silicon has a purity of at least 95% and less than 99.9%, less than 99.8%, less than 99.5%, less than 99%, less than 98%, or less than 96%. The solid silicon structures may be doped with boron, arsenic, phosphorus, iron, chromium, aluminum, or a combination thereof.

In some case, the nanoporous silicon structures are coated with carbon by decomposition of a carbon-containing compound before combining the nanoporous silicon structures with the binder. The coated nanoporous silicon structures may be further coated with reduced graphene oxide before combining the nanoporous silicon structures with the binder.

In a fifth general aspect, a lithium ion battery comprising an electrode formed by the method of the fourth general aspect.

In a sixth general aspect, a device includes the lithium ion battery of the fifth general aspect.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A depicts a lithium ion battery. FIG. 1B depicts a device including the lithium ion battery of FIG. 1A.

FIG. 2A depicts a nanoporous silicon structure. FIG. 2B depicts one unit of the nanoporous structure used for theoretical simulation and analysis. FIG. 2C shows pore size before and after lithiation at fixed pore-to-pore distance (l=12 nm). FIG. 2D shows the corresponding maximum stress at fixed pore-to-pore distance (l=12 nm). FIG. 2E shows size before and after lithiation for fixed pore/edge ratio (r/l=1/3). FIG. 2F shows corresponding maximum stress versus initial pore size at fixed pore/edge ratio (r/l=1/3).

FIG. 3A shows partial density of states of iron and aluminum as impurities in metallurgical grade silicon. FIG. 3B shows charge distribution of electrons in an energy range of ±0.3 eV with respect to the Fermi level for iron and aluminum impurities in a silicon matrix.

FIG. 4 depicts a process including doping and etching of silicon nanoparticles.

FIG. 5A shows a scanning electron microscope (SEM) image of nanoporous silicon nanowires etched with 0.02M AgNO₃. FIG. 5B shows a transmission electron microscope (TEM) image of nanoporous silicon nanowires. FIGS. 5C and 5D show high resolution TEM (HRTEM) images of a nanoporous silicon nanowire shown in FIG. 5B.

FIG. 5E shows a selected area electron diffraction (SAED) pattern of a single nanoporous silicon nanowire. FIG. 5F shows pore size distributions of nanoporous silicon nanowires etched with 0.02 M AgNO₃ and 0.04M AgNO₃.

FIG. 6A shows a charge/discharge profile of a nanoporous silicon nanowire within a voltage window of 0.01-2 V vs. Li⁺/Li for the 1^{st} cycle at a current rate of 0.4 A/g, and the 50^{th}, 100^{th}, and 200^{th} cycles at 2 A/g. FIG. 6B shows cyclic voltammetry curves of a nanoporous silicon nanowire electrode for the 1^{st} and 2^{nd} cycles using a voltage window of 0.01-2 V at rate of 0.1 mV/s. FIG. 6C shows charge/discharge capacity and Coulombic efficiency of a nanoporous silicon nanowire electrode at current rates of 0.6, 1.2, 2.4, 3.6, 4.8, and 9.6 A/g. FIG. 6D shows charge/discharge capacity of a nanoporous silicon nanowire electrode at current rates of 2, 4, and 18 A/g for 250 cycles. FIG. 6E shows charge/discharge capacity of a nanoporous silicon nanowire electrode with an alginate binder at current rates of 2 and 4 A/g. FIG. 6F shows charge/discharge capacity of a nanoporous silicon nanowire electrode with a polyvinylidene fluoride (PVDF) binder at current rates of 0.5, 1, and 2 A/g.

FIGS. 7A and 7B show TEM images of nanoporous silicon nanowires before and after lithiation, respectively, after 10 cycles at a current rate of 0.4 A/g. FIG. 7C is an enlarged TEM image of the nanowire shown in FIG. 7B showing the amorphous silicon structure. FIG. 7D shows a SAED pattern indicating that the black spots in FIG. 7B are crystalline silicon.

FIG. 8A shows a TEM image of nanoporous silicon formed from metallurgical grade silicon after etching with AgNO₃ and HF. FIG. 8B shows a TEM image of nanoporous silicon formed from metallurgical grade silicon after a second etching with H₂O₂ and HF. FIG. 8C-8E show TEM images of nanoporous silicon formed from metallurgical grade silicon after etching with Fe(NO₃)₃ and HF, Cu(NO₃)₂ and HF, and HAuCl₄ and HF, respectively.

FIG. 9A shows specific capacity and Coulombic efficiency for nanoporous silicon etched from metallurgical silicon as anode at various current rates. FIG. 9B shows cycling performance of a nanoporous silicon anode at a current rate of 0.4 A/g for 100 cycles.

FIG. 10A shows boron density of as-obtained doped silicon nanoparticles at different initial H₃BO₃:Si ratios. FIG. 10B is a TEM image of a doped silicon nanoparticle before etching. FIGS. 10C-10E are TEM images of nanoporous silicon nanoparticles synthesized with initial H₃BO₃:Si of 5:2, 5:4, and 5:8, respectively. FIG. 10F shows a TEM image of nanoporous silicon nanoparticles with silver particles after etching but before washing. FIG. 10G is a TEM image of nanoporous silicon nanoparticles shown in FIG. 10F after washing with HNO₃ and H₂O. FIG. 10H shows an X-ray diffraction (XRD) pattern of solid silicon nanoparticles, boron doped silicon nanoparticles, and nanoporous silicon nanoparticles.

FIG. 11A shows a charge/discharge profile within a voltage window of 0.01-2 V vs. Li⁺/Li at current rates of 1/20 C and 1/10 C. FIG. 11B shows charge/discharge capacity and Coulombic efficiency of nanoporous silicon nanoparticles (carbon coated) at current rates of 1/20 C and 1/10 C. FIG. 11C shows charge/discharge capacity and Coulombic efficiency of solid silicon nanoparticles (carbon coated) at a current rate of 1/10 C using alginate binder. FIG. 11D shows charge/discharge capacity of solid silicon nanoparticles (carbon coated) at initial current rates of 1/10 C and 1/70 C using an alginate binder.

FIG. 12A shows charge/discharge capacity of nanoporous silicon nanoparticles (carbon coated, wrapped with reduced graphene oxide) at current rates of 1/16 C, 1/8 C, 1/4 C, and 1/2 C. FIG. 12B shows long cycle performance of reduced graphene oxide wrapped nanoporous silicon nanoparticles (carbon coated) at 1/4 C, 1/2 C, and 1 C, along with capacity of pure reduced graphene oxide.

### DETAILED DESCRIPTION

Nanoporous silicon has a large surface area accessible to electrolytes, short diffusion length for lithium ions, large space available to accommodate volume change, and high electron conductivity. As described herein, nanoporous silicon generally refers to silicon structures having pores with a mean diameter in a range from 1 nm to 200 nm, (e.g., 1 nm to 100 nm or 5 nm to 50 nm) and a mean distance between adjacent pores (e.g., the thickness of a wall between adjacent pores) in a range from 1 nm to 200 nm (e.g., 1 nm to 100 nm or 5 nm to 50 nm). The ratio of pore diameter to wall thickness is typically in a range between 1:5 and 2:1 (e.g., 1:1). “Porous” and “nanoporous” are used interchangeably herein to mean “nanoporous.” The silicon structures described herein include silicon particles and silicon nanowires. The silicon nanowires described herein have a length of 100 μm or less (e.g., 10 μm or less or 1 μm or less) and a diameter of less than 100 nm (e.g., between 1 nm and 10 nm). The silicon particles described herein have a mean diameter of 10 μm or less (e.g., 5 μm or less, 1 μm or less, between 1 μm and 10 μm, 1000 nm or less, 500 nm or less, 200 nm or less, or 100 nm or less). Thus, silicon particles described herein may be silicon nanoparticles, with a mean diameter of 100 nm or less, 500 nm or less, or 1000 nm or less.

As shown herein, nanoporous silicon exhibits superior electrochemical performance and long cycle life as anode material in lithium ion batteries. Even after 250 cycles, capacity remains stable above 2200 mAh/g, 1600 mAh/g, and 1100 mAh/g at current rates of 2 A/g, 4 A/g, and 18 A/g, respectively. In one example, a battery fabricated as described herein has recorded 1600 cycles with capacity remaining above 1000 mAh/g.

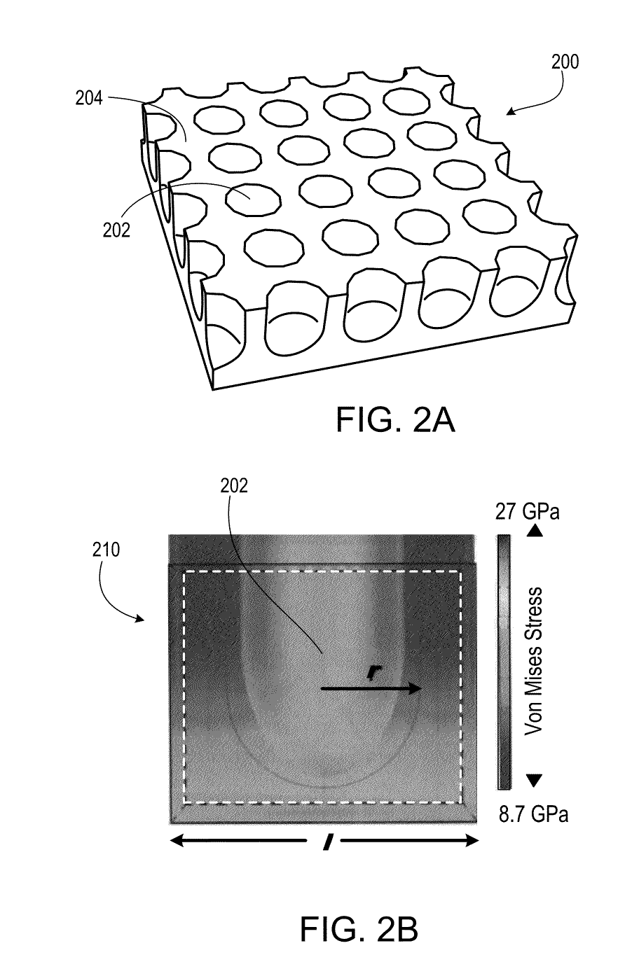

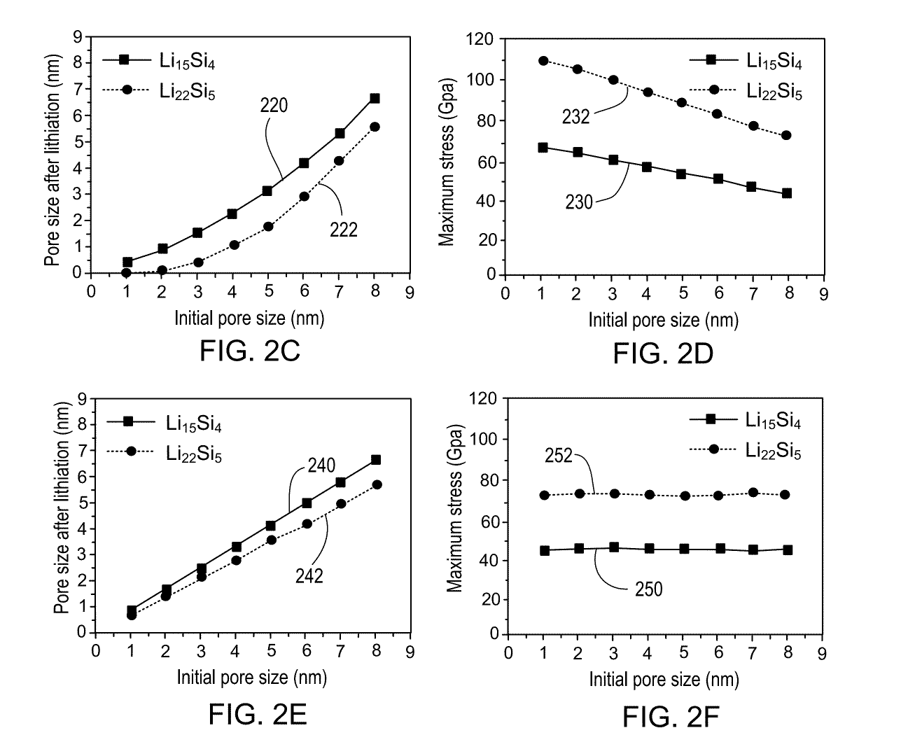

Simulations were carried out to illustrate strain induced by lithium ion diffusion. A mathematical model coupling lithium ion diffusion and the strain induced by lithium intercalation was employed to study the effects of porosity and pore size on the structure stability. FIG. 2A depicts nanoporous silicon structure 200 with pores 202 and walls 204 defining the pore-to-pore distance between the pores. FIG. 2B depicts results of calculation and analysis carried out on one unit 210 of the structure in FIG. 2A, including one pore 202 having a radius r and a pore-to-pore distance l. Insertion of lithium generates stress in the silicon matrix, and the strain induced by stress not only deforms the structure (expansion), but also compromises the lithium diffusion.

FIG. 2C shows the pore size evolution after lithium ion intercalation at fixed pore-to-pore distance (l=12 nm) for Li₁₅Si₄ and Li₂₂Si₅ as plots 220 and 222, respectively. Plots 220 and 222 show that the pore diameter after lithium intercalation decreases with decreasing initial pore size. Plots 230 and 232 in FIG. 2D show that the maximum stress around the pore increases as the initial pore size is decreased at fixed pore-to-pore distance (l=12 nm) for Li₁₅Si₄ and Li₂₂Si₅, respectively, which act as a source of fracture.

In FIGS. 2E and 2F, porosity is fixed by means of fixing the ratio of initial pore radius (r) and pore-to-pore distance (l). Plots 240 and 242 in FIG. 2E show the correlation of pore sizes before and after lithiation for Li₁₅Si₄ and Li₂₂Si₅, respectively. Plots 250 and 252 in FIG. 2F show little change in the maximum stress at different pore sizes for Li₁₅Si₄ and Li₂₂Si₅, respectively. Thus, decreasing the ratio r/l to a low value (low porosity) tends to increase maximum stress, and smaller initial pore results in higher maximum stress around the pore. Therefore, silicon with high porosity and large pore size is shown to maintain its structure after lithium ion intercalation while having low stress, which stabilizes electrode structure during the charge/discharge process and is beneficial for obtaining high capacity and long cycle retention.

In practice, low diffusivity of lithium ions in silicon generates a lithium ion concentration gradient that may compromise the charge/discharge capacity: the larger the concentration gradient, the lower the charge/discharge capacity. For nanoporous silicon, electrolyte permeates the pores, and lithium intercalation occurs in regions where the electrolyte contacts silicon. Multi-site intercalation is believed to allow nanoporous silicon to have more uniform lithium ion concentration than solid silicon structures or nanostructures at the same charge/discharge rate, therefore leading to higher capacity. Doping (e.g., with boron, phosphorus, arsenic, iron, chromium, or aluminum) is thought to increase electron conductivity in silicon, thereby promoting high capacity at high current rate.

Chemical etching (electro- and electroless) is a versatile approach to form pores in various silicon substrates. By selecting the etchant, the type of silicon substrate to be etched, and the etching conditions, nanoporous silicon structures can be formed and used as an active material for solar cells, bio-applications, thermoelectric usage, and lithium ion battery electrodes. As described herein, nanoporous silicon structures include nanoporous silicon particles having a mean diameter of 10 μm or less, as well as and nanoporous silicon nanostructures (e.g., nanoporous nanoparticles having a mean diameter of 1000 nm or less and silicon nanowires and).

Nanoporous silicon nanowires can be prepared by contacting doped silicon wafers in an etchant solution for a length of time (e.g., 1 to 10 hours). Suitable dopants include, for example, boron, phosphorus, arsenic, iron, chromium, aluminum, or a combination thereof. Suitable etchant solutions include solutions of metal salts, such as iron nitrate, iron chloride, silver nitrate, chloroauric acid, copper nitrate, copper chloride, cobalt (III) nitrate, cobalt (III) chloride, in a strong acid. In one example, the strong acid is hydrofluoric acid, or ammonium fluoride combined with hydrofluoric acid or nitric acid or sulfuric acid or hydrochloride acid. The concentration of the strong acid is typically in a range between 1 M to 10 M, and the concentration of the metal salt is typically in a range between 0.01 M and 1 M (e.g., 0.05 M to 0.2 M).

In the example of an etching process with an etchant including silver nitrate and hydrofluoric acid shown below,

4Ag⁺+4e⁻→4Ag (1)

Si+6F⁻→[SiF₆]²⁻+4e⁻ (2)

silicon donates electrons to reduce Ag⁺ to Ag. Since the redox potential of Ag⁺/Ag lies below the valance band of silicon, for p-type silicon, higher dopant concentration (lower Fermi level) decreases the energy barrier for electrons transferring from silicon to silver, thus facilitating the etching process to generate larger pores. Impurities in silicon, such as boron dopants, provide defective sites that act as nucleation sites for pore formation, thus forming pores in the resulting silicon nanowires. Similar etching processes occur for etchants including iron nitrate, iron chloride, chloroauric acid, copper nitrate, copper chloride, cobalt (III) nitrate, and cobalt (III) chloride in a strong acid

As described herein, pores formed in silicon nanowires have a mean diameter in a range between 1 nm and 100 nm (e.g., less than the diameter of the nanowire, or between 1 nm and 50 nm or between 5 nm and 20 nm). An average thickness of the wall between pores ranges between 1 nm and 50 nm. In some cases, the ratio of pore diameter to wall thickness is about 1:1, or in a range between 1:5 and 2:1.

Nanoporous silicon particles have been formed from metallurgical grade silicon as well as from solid silicon nanoparticles, both of which can be etched in bulk to produce a large quantity of nanoporous silicon. The lower cost of metallurgical grade silicon makes this starting material particularly advantageous.

Metallurgical grade silicon can be used as received without further purification to remove common impurities such as iron, aluminum, and the like. Purity of the metallurgical grade silicon is at least 95% and less than 99.9% (e.g., less than 99.8%, less than 99.5%, less than 99%, less than 98%, or less than 96%). To produce nanoporous silicon from metallurgical grade silicon, metallurgical silicon is milled into to small particles (e.g., several to tens of micrometers) using wet ball mill technology. Ethanol or other non-oxidant solvents can be used as additive in the ball mill process. In one example, the mass ratio of silicon:ball:additive is around 1:5:1, but other ratios can be used as well. As obtained, microsized silicon is collected and washed (e.g., with dilute hydrofluoric acid, 1-5 wt %) to remove oxide layer at the surface of the particles. The silicon particles are then immersed into an etchant solution (e.g., as described with respect to silicon wafers herein), and kept static for a length of time (e.g., from 1 to 10 hours) to yield nanoporous silicon structures. A mean diameter of the nanoporous silicon is 10 μm or less (e.g., 5 μm or less, 1 μm or less, between 1 μm and 10 μm, 1000 nm or less, 500 nm or less, 200 nm or less, or 100 nm or less). Thus, silicon particles described herein may be silicon nanoparticles, with a mean diameter of 1000 nm or less, 500 nm or less, or 100 nm or less. The pores formed have a mean diameter in a range from 1 nm to 200 nm, (e.g., 1 nm to 100 nm or 5 nm to 50 nm) and a mean distance between adjacent pores (e.g., the thickness of a wall between adjacent pores) in a range from 1 nm to 200 nm (e.g., 1 nm to 100 nm or 5 nm to 50 nm). The ratio of pore diameter to wall thickness is typically in a range between 1:5 and 2:1 (e.g., 1:1).

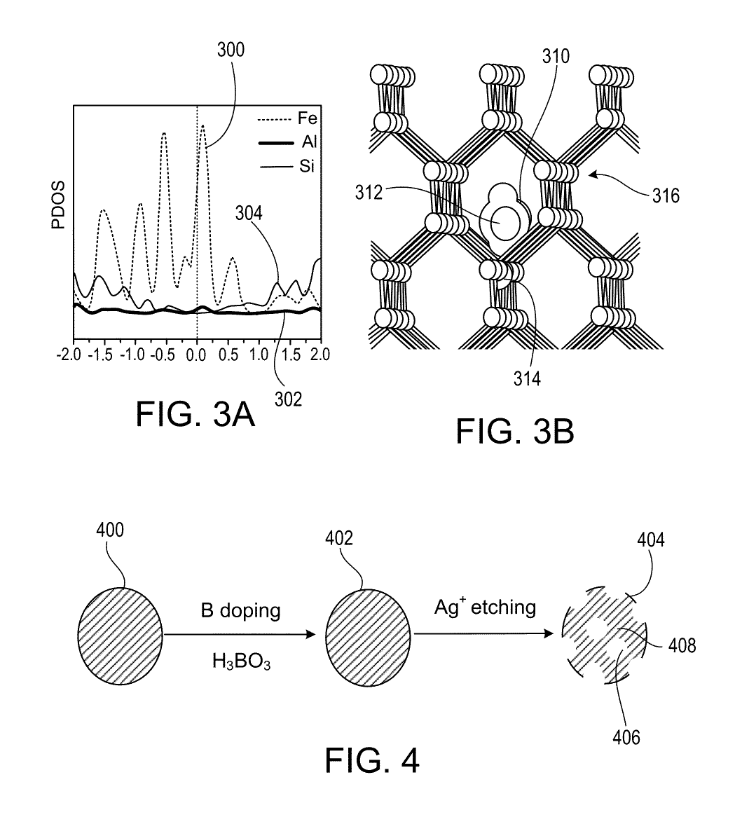

It is believed that impurities present in the silicon (e.g., Fe, Al) contribute at least in part to the formation of pores in the etching process. Moreover, these impurities advantageously occur without the need of a doping process. As seen in FIG. 3A, theoretical calculations show that the energy level of Fe (plot 300) and Al (plot 302) lie in the valance band of silicon (plot 304), which allows Fe and Al to function as p-type dopants in silicon. FIG. 3B shows the charge distribution profile in the energy range of ±0.3 eV with respect to the Fermi level, in which charge 310 is thought to be mostly localized around iron atoms 312 (rather than aluminum atoms 314) in silicon matrix 316. In a silver nitrate/hydrofluoric acid etching process, silicon donates electrons to reduce Ag⁺ to Ag, which can be etched away by HF. According to the analysis of charge distribution shown in FIG. 3B, dopant sites where iron locates are preferentially etched by Ag⁺, forming nanopores in the particles.

To further increase the porosity, a second etching step can be employed. Typically, etchant solution containing a strong acid (e.g., hydrofluoric acid) and an oxidizing agent (e.g., hydrogen peroxide) is prepared. A range of concentration of the strong acid is 1 M to 10 M, and a range of oxidizing agent is 0.1 M to 1 M. A small amount of ethanol (or other solvent, such as methanol or isopropanol) can be added to increase the wettability to silicon. Nanoporous silicon formed as described above from metallurgical grade silicon (e.g., without washing with HNO₃) is immersed in the etchant solution and kept static for a length of time (e.g., 1 to 10 hours), and washed and dried to yield a nanoporous silicon particles (e.g., powder.)

The second etching step is believed to further increase porosity for at least the following reasons. In the first etching process, excess silver nanoparticles (or other metals, depending on the etchant) may at least partially cover the surface of silicon, thereby blocking the etching path and inhibiting the etching process. After washing, some silver nanoparticles on the surface of the silicon particles are removed, and some of the silver nanoparticles remain embedded in the nanoporous silicon matrix. In the second etching process, silicon is isotropically oxidized (e.g., by H₂O₂) and etched away (e.g., by HF), thereby increasing the pore size. In addition, the silver nanoparticles embedded in the silicon matrix can be oxidized to Ag⁺ by the oxidizing agent, and can continue to etch the silicon, thereby increasing the porosity beyond that observed after the first etching process.

In some embodiments, an electroless etching process is used to synthesize nanoporous silicon nanoparticles from solid silicon nanoparticles, available in large quantities, as raw material. The silicon nanoparticles may be doped before etching. Suitable dopants include, for example, boron, phosphorus, arsenic, iron, chromium, aluminum, or a combination thereof. In other cases, silicon nanoparticles are obtained with selected dopants or impurity levels suitable for etching. A mean diameter of the silicon nanoparticles and pores are as described herein, and typically in a range between 50 nm and 1000 nm (e.g., between 50 nm and 500 nm, between 50 nm and 250 nm, or between 75 nm and 150 nm). A mean diameter of the nanopores is in a range between 1 nm and 200 nm, or between 5 nm and 50 nm.

Boron doping is described here as an example of doping of silicon. In one embodiment, boron doping of silicon is based on the decomposition of boric acid to generate boron atoms which subsequently diffuse into the silicon at elevated temperature. The process is described the following reactions:

2H₃BO₃→B₂O₃+3H₂O (3)

2B₂O₃+Si→3SiO₂+4B (4)

The total boron concentration inside the silicon at time t can be calculated based on Fick's equation, then integrated over whole volume. As a simplified model in one dimension:

$$C ( t ) = \int {C}_{s} erfc ( \frac{x}{2 \sqrt{DT}} ) = \frac{2}{\sqrt{π}} {C}_{s} \sqrt{Dt}$$

where Cₛ is surface concentration of boron atoms and D is diffusion coefficient. According to the simplified model, the different boron doping density can be adjusted by changing the initial boric acid concentration.

Doped silicon nanoparticles are subjected to an etching process with an acidic metal salt solution similar to that described above for silicon wafers and metallurgical (e.g., doped or undoped) silicon particles. The resultant pore size in the nanoporous nanoparticles can be tuned via an etching process, for example, by adjusting the mass ratio of dopant to silicon nanoparticles during the doping process. FIG. 4 depicts a process in which solid silicon nanoparticles 400 are doped to form doped silicon nanoparticles 402. Doped silicon nanoparticles 402 are then etched to form nanoporous nanoparticles 404 defining pores 406. Pores 406 in nanoporous nanoparticles 404 have a mean diameter in a range between 1 nm and 50 nm (e.g., between 5 nm and 20 nm). An average thickness of wall 408 between pores ranges between 1 nm and 50 nm. In some cases, the ratio of pore diameter to wall thickness is about 1:1, or in a range between 1:5 and 2:1.

Nanoporous silicon structures described herein can be further coated with carbon, for example, by decomposition of ethylene or acetylene at high temperature under inert atmosphere. In some cases, nanoporous silicon structures are further coated (wrapped) with reduced graphene oxide, which serves as an elastic and electronically conductive substrate and promotes good dispersion of the nanoparticles. The coating of graphene oxide on silicon structures can be achieved by mixing the silicon structures with graphene oxide in a proper weight ratio (e.g., between 2:1 and 20:1) in water under stirring for 1 to 10 hours, and then drying to yield powders. Such coatings typically protect the silicon structures (e.g., by acting as a passivation layer to reduce side reactions), provide mechanical support, and also act as a conductive coating to enhance electron transport, thus improving the overall performance of the nanoporous silicon structures in lithium ion battery electrodes.

The nanoporous silicon structures described herein can be mixed with carbon black (e.g., in a ratio of silicon:carbon black of 1:1 to 4:1) and mixed with a binder to form a uniform slurry. Other additives may be included in the slurry. The binder may be present in a range of 5-25 wt % based on the silicon, carbon black, and binder. Suitable binders include, for example, polyvinylidene fluoride (PVDF) and an alginate salt (e.g., sodium alginate, lithium alginate, potassium alginate, calcium alginate, and ammonium alginate) commercially available as an alginate binder. The binder may have a viscosity in the range of 200 cP to 2000 cP at room temperature, however, high viscosity binders (e.g., around 1000 cP or greater), such as the alginate binder (2000 cP at 2 wt %) are found to improve structural stability of an electrode during cycling.

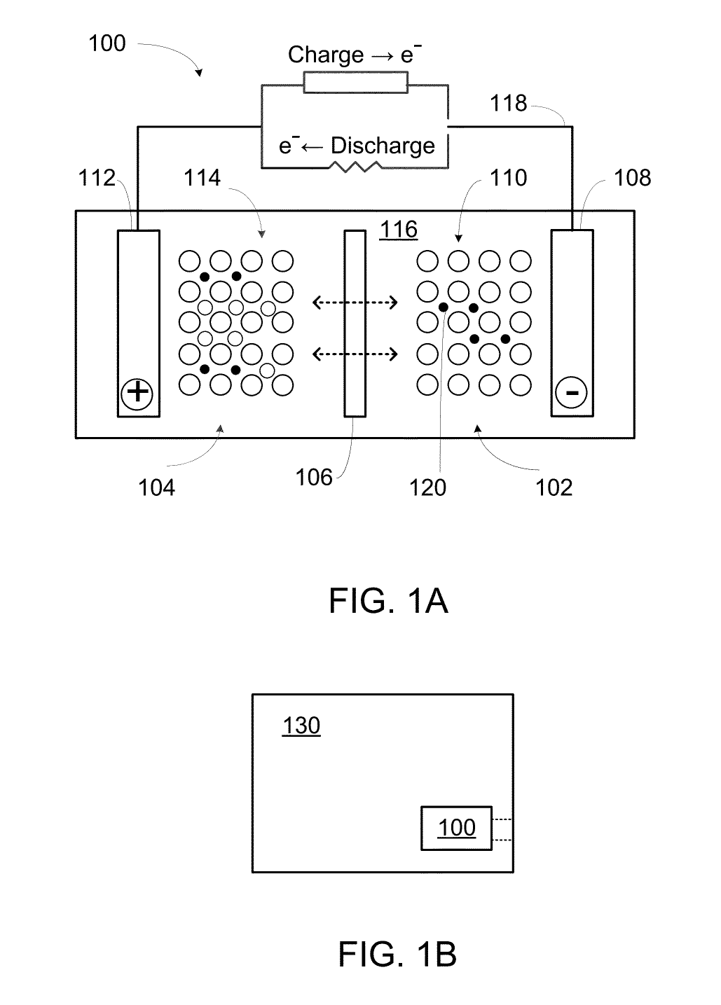

The composition including nanoporous silicon, carbon black, and binder is then applied to a conductive substrate such as a copper foil to form an electrode for a lithium ion battery. The electrode is dried, and the battery is assembled in an inert atmosphere with the nanoporous silicon anodes and lithium metal foil counter electrodes (e.g., as generally depicted in FIG. 1A). The battery may be in the form of a coin cell, with an electrolyte such as 1 M LiPF₆ dissolved in a 1:1 (weight ratio) mixture of ethylene carbonate (EC) and diethyl carbonate (DEC).

Improved anode performance shown herein may be attributed to the nanoporous silicon in at least two aspects. First, the pores on surface can accommodate the large volume change of silicon (up to 300%) during lithiation and delithiation, which helps to maintain particle integrity and good contacts between silicon and carbon black. Second, the nanoporous structure increases the interface area between electrolyte and silicon, thereby facilitating more lithium ions diffusing into silicon at a time; thereby preserving high capacity at high charge/discharge rate, due at least in part to the small diffusing rate of lithium ions in silicon.

The examples below show that nanoporous silicon can be used as anode material in lithium ion batteries to achieve large specific capacity, high power density, and superior cyclability. The nanoporous silicon shows good electrochemical performance as an anode material for lithium ion batteries, yielding a specific capacity larger than 1000 mAh/g after 100 cycles at current rate of 0.1 C. Comparing with non-porous silicon which show a capacity less than 300 mAh/g, the performance improvement may be attributed to the unique nanoporous structure, which is able to accommodate large volume change during cycling and provides a larger interphase area between electrolyte and silicon that facilitate the lithium ion intercalation process.

In some embodiments, silicon particles are prepared from silicon precursors in a plasma process. Plasma can be generated using electric power originating from DC (direct current), AC (alternate current), RF (radio frequency), or microwave sources. It offers high temperature environment (5000-10000K), and therefore can be used to produce silicon particles in a large quantity. It is an alternative, cost-efficient way to produce silicon particles, and can be combined with ball milling to produce silicon particles. Typically, silicon precursor in either liquid form (e.g., SiCl₄) or solid form (metallurgical silicon) is sent into the plasma torch regime along with the flow of carrier gas (e.g., Ar), and the precursor is decomposed and quenched to get silicon particles with particle size ranging from 5 nm to 1000 μm. Doping with various elements (e.g., boron, iron, arsenic, phosphorus, chromium, aluminum) can be achieved simultaneously by introducing dopant precursor (e.g., boric acid, iron nitrate, arsenic oxide, phosphoric acid, chromium chloride, aluminum nitrate, etc.) in the reaction.

In yet other embodiments, silicon particles are prepared from liquid silicon precursors, such as silicon tetrachloride (SiCl₄), trichlorosilane (SiHCl₃), and dichlorosilane (SiH₂Cl₂). Such silicon precursors can be decomposed to produce silicon particles through chemical vapor deposition (CVD) in an inert or H₂ protected environment. The reactions are shown below.

SiCl₄+2H₂→Si+4HCl (5)

SiHCl₃+H₂→Si+3HCl (6)

SiH₂Cl₂→Si+2HCl (7)

The decomposition temperature is usually above 1000° C., however, it can be lowered (<1000° C.) by introducing catalysts such as Au, Pt, Pb, Fe, Ni, Cr. Doping of silicon can be achieved by introducing some dopant precursor (e.g., borane, phosphine). The obtained silicon particles, with a mean diameter in a range between 10 nm and 500 nm, can be used as starting material for a further etching procedure to yield nanoporous silicon particles.

### EXAMPLES

### Example 1

### Lithium Ion Battery Electrodes with Nanoporous Silicon Nanowires

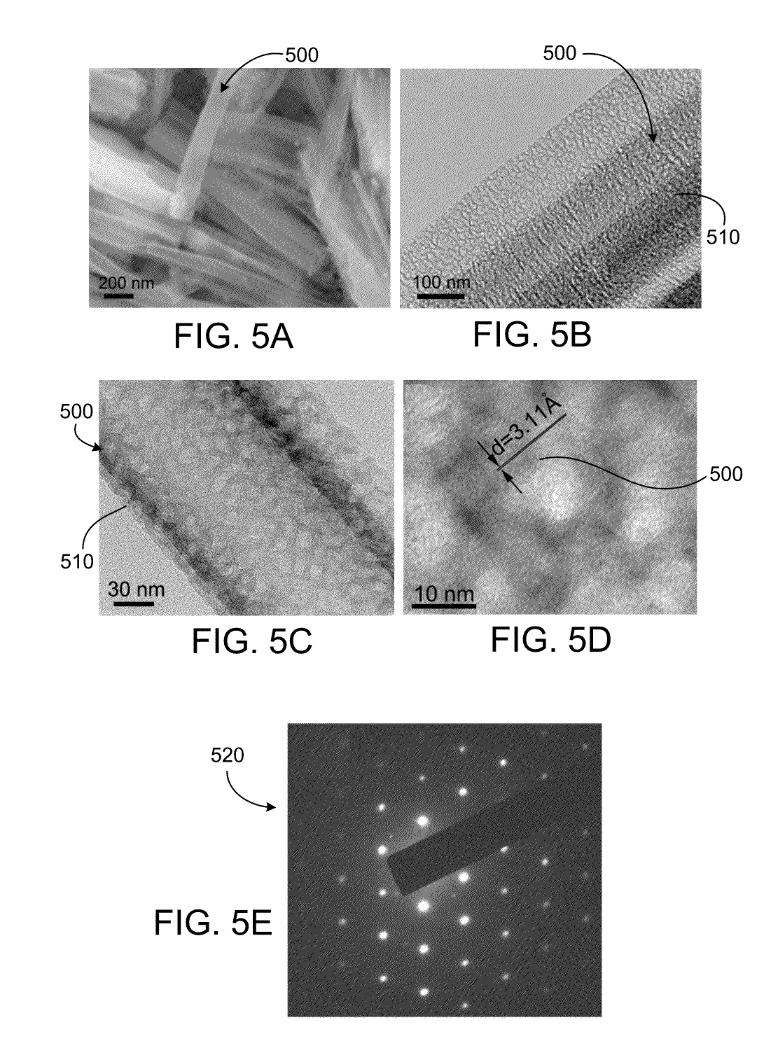

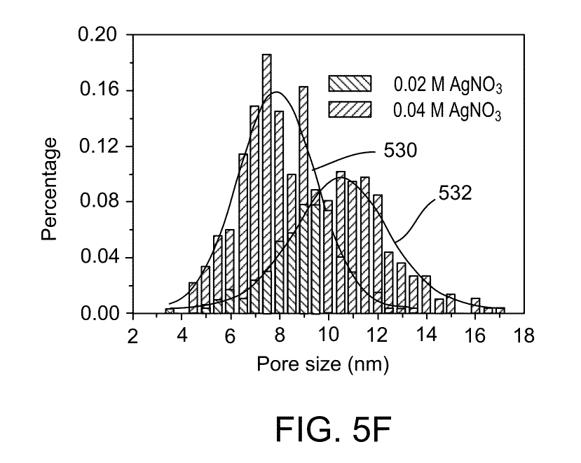

Nanoporous silicon nanowires were prepared by immersing boron-doped silicon wafers (resistivity<5 mΩ·cm) in an etchant solution containing 5 M hydrofluoric acid (HF) and 0.02 M silver nitrite (AgNO₃) for 3 hours. The resulting nanoporous nanowires were washed by de-ionized water (DI-H₂O), concentrated nitric acid (HNO₃), and DI-H₂O again sequentially, and then collected by scratching from the wafers using a blade. FIG. 5A shows a scanning electron microscopy (SEM) image of nanoporous silicon nanowires 500, and FIGS. 5B-5D show transmission electron microscopy (TEM) images of nanoporous silicon nanowires 500. Nanoporous silicon nanowires 500 are highly porous at the surface, with pores 510 having a diameter and a wall thickness of about 8 nm. The high resolution TEM image in FIG. 5D shows crystalline nanowires with clear lattice fringes corresponding to Si (111). The crystalline structure was also confirmed by the spot pattern 520 in SAED taken on a single nanoporous silicon nanowire, as shown in FIG. 5E.

FIG. 5F shows distribution of pore sizes obtained by etching the Si wafer with different concentrations of AgNO₃. Etchants containing 0.02 M and 0.04 M AgNO₃ gave distributions 530 and 532 with pores having mean diameters of 7.8±0.1 nm and 10.5±0.1 nm (e.g., between 5 nm and 15 nm), respectively, based on statistical analysis of TEM images.

To test the electrochemical performance of nanoporous silicon nanowires, two-electrode coin cells using nanoporous silicon nanowires as the anode and lithium metal as the counter electrode were fabricated. The electrode was made by mixing the nanoporous silicon nanowires with SuperP conductive carbon black and alginic acid sodium salt (alginate binder, Sigma Aldrich, viscosity ˜2000 cP at 2 wt %) in water to form a uniform slurry (mass ratio of silicon:SuperP=2:1, alginate binder: 15 wt %) and then spread on a copper foil using a stainless steel blade. The electrode was dried at 90° C. overnight in air. Then CR2032 coin cells were assembled in an argon-filled glovebox using the as-prepared nanoporous silicon nanowire anodes as working electrodes and lithium metal foil as counter electrodes. The mass loading of cells is around 0.3 mg/cm². The electrolyte was 1 M LiPF₆ dissolved in a 1:1 (weight ratio) mixture of ethylene carbonate (EC) and diethyl carbonate (DEC).

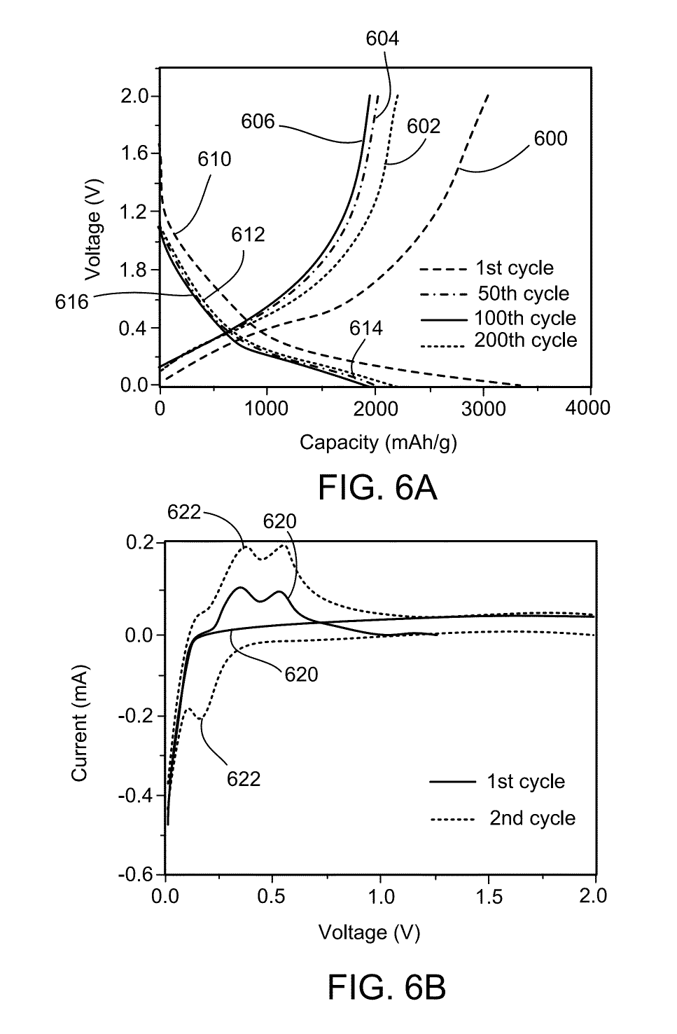

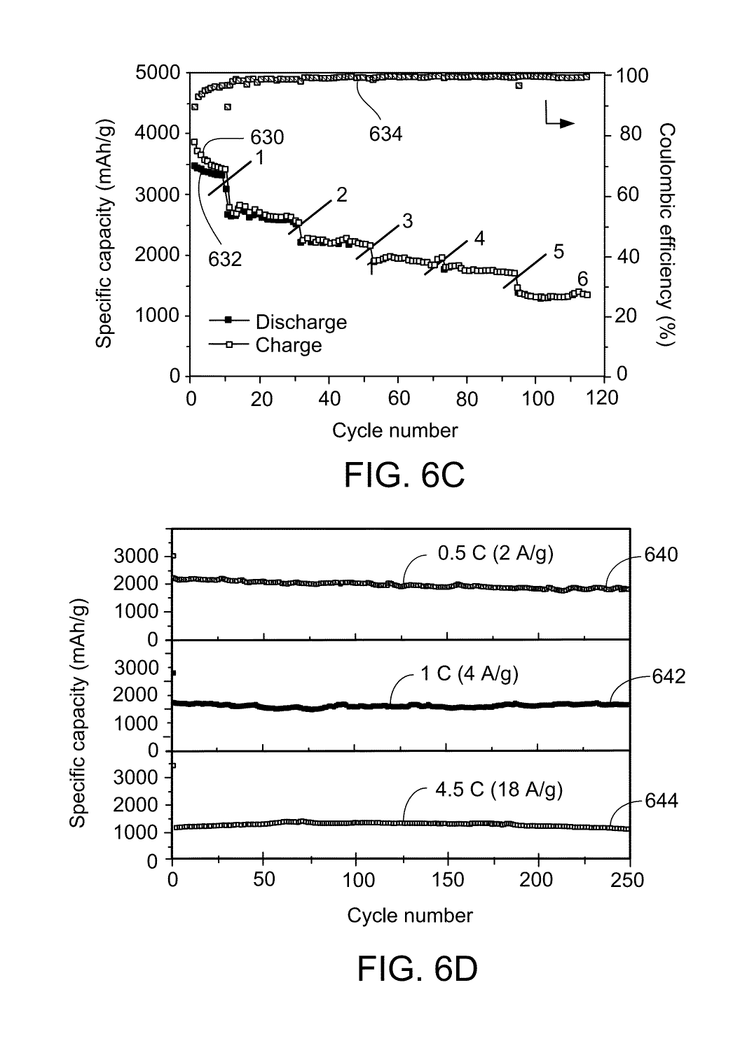

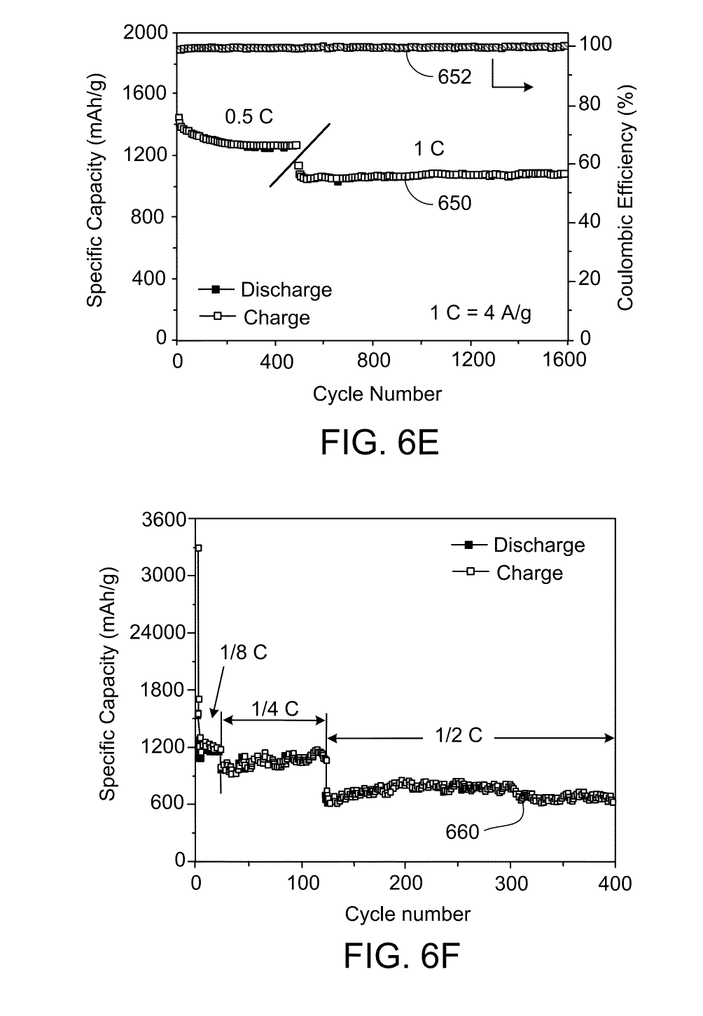

FIG. 6A shows the voltage profile in the charge (lithiation) and discharge (delithiation) process in the potential window of 0.01-2.0 V vs Li⁺/Li. Charge cycles 600, 602, 604, and 606 and discharge cycles 610, 612, 614, and 616 are shown for the 1^{st}, 50^{th}, 100^{th}, and 200^{th} cycles, respectively. The 1^{st} cycle at current rate of 0.4 A/g showed charge capacities and discharge capacities of 3354 mAh/g and 3038 mAh/g, respectively. Cycles from 20^{th} and thereafter ran at a current density of 2 A/g and showed capacity degradation of only about 9% per 100 cycles. After 200 cycles, capacity was still above 1960 mAh/g, indicating good structure stability of the nanoporous silicon nanowires.

Transition from crystalline silicon to amorphous structure during cycling was confirmed by cyclic voltammetry (C-V) curves at the 1^{st} and 2^{nd} charge/discharge cycles shown by plots 620 and 622, respectively, in FIG. 6B. During the 2^{nd} cycle, the peak at 0.15 V, which is absent at the 1^{st} cycle at cathodic branch (lithiation), indicates the crystal-to-amorphous transition.

FIG. 6C shows the charge/discharge capacity as plots 630 and 632, respectively and Coulombic efficiency as plot 634 at different current rates. The capacity remained above 3400, 2600, 2000, 1900, 1700, and 1300 mAh/g at current densities of 0.6, 1.2, 2.4, 3.6, 4.8 and 9.6 A/g (steps 1-6), respectively. The Coulombic efficiency was around 90% at first several cycles, believed at least in part to be due to the large surface area of nanoporous silicon that needs a longer time to form a stable solid electrolyte interface (SEI) layer. After 20 cycles, the Coulombic efficiency exceeded 99.5% at each different current rate cycling step. The charging/discharging time, current rate, and average specific capacity at different current rates are summarized in Table 1. Table 1 indicates that even at high current rate (2.4 C=9.6 A/g at step 6), charging/discharging finished within 10 minutes still gave capacity above 1300 mAh/g, equivalent to 38% of capacity using 0.15 C (step 1).

TABLE 1
Charging/discharging time, current rate, and average
specific capacity at different current rates.

| | | Charging/ | | Current rate | Average specific |
|---|---|---|---|---|---|
| Step | Number | discharging | | (1 C = 4000 | capacity |
| number | of cycle | time | | mAh/g) | (mAh/g) |
| 1 | 10 | 6 | h | 0.15 C | >3400 |
| 2 | 20 | 2 | h | 0.30 C | >2600 |
| 3 | 20 | 1 | h | 0.60 C | >2000 |
| 4 | 20 | 40 | min | 0.90 C | >1900 |
| 5 | 20 | 30 | min | 1.20 C | >1700 |
| 6 | 20 | 10 | min | 2.40 C | >1300 |

FIG. 6D shows long cycle performance at charging/discharging rate of 0.1 C for the 1^{st} cycle, and 0.5 C, 1 C, and 4.5 C (plots 640, 642, and 644, respectively) for additional 250 cycles, which shows stable capacities around 2200, 1600, and 1100 mAh/g, respectively. Capacity degradation is almost negligible in each case, demonstrating good stability of the nanoporous silicon structure. A commercially available alginate binder (Sigma Aldrich, Cat. No. A2033) with low viscosity (2000 cP at 2 wt %, room temperature) was used. FIG. 6E shows overlapping charge/discharge capacity as plot 650 and Coulombic efficiency 652, with improved cyclability thought to be due at least in part to the use of nanoporous silicon structures as well as the commercial alginate (e.g., compared to PVDF). As seen in plot 650 of FIG. 6E, a capacity remaining above 1000 mAh/g was maintained for 1600 cycles.

Plot 660 in FIG. 6F shows charge/discharge capacity for a lithium ion battery anode including nanoporous silicon nanowires with PVDF as a binder at current rates of 0.5 A/g, 1 A/g, and 2 A/g. Comparison of FIGS. 6E and 6F indicates that the alginate binder yields an electrode with a higher specific capacity than the PVDF binder. However, the capacity retention is still good after 100 cycles at 1/4 C rate (1 A/g), and stabilizes above 600 mAh/g at 1/2 C (2 A/g).

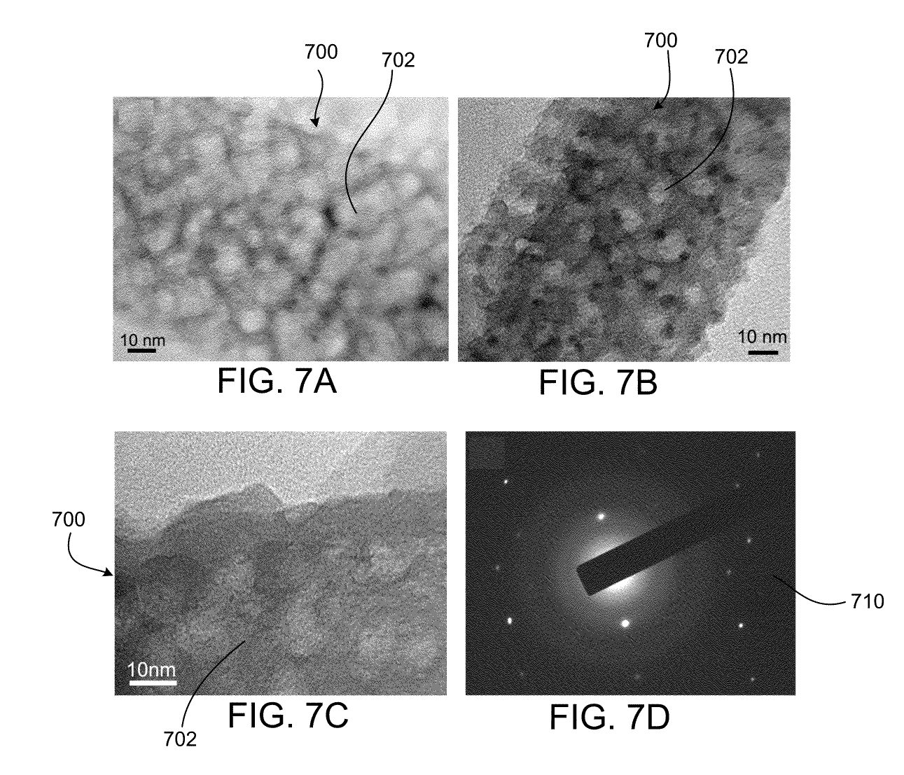

To determine the morphology change of the nanoporous silicon nanowires, several batteries after 10 cycles running at 0.1 C (0.4 A/g) were disassembled, and the silicon anodes were washed with acetonitrile and 0.5 M HNO₃ to remove the SEI layer, and then dissolved in ethanol to make samples for TEM observation. FIGS. 7A and 7B show TEM images of a nanoporous silicon nanowires 700 with pores 702 before cycling (FIG. 7A) and after cycling (FIGS. 7B and 7C). FIG. 7B shows that nanowire 700 remains highly porous, and pore size does not change significantly after cycling (e.g., compared to FIG. 7A). This agrees well with theoretical analysis showing that nanoporous silicon with a large initial pore size and high porosity would not change its structure significantly after lithiation.

As seen in FIGS. 7A-7C, the initial pore diameter was around 8 nm and the wall between adjacent pores had thickness about 6 nm (FIG. 7A); after cycling, the pore diameter and wall thickness were still around 7-8 nm. The nanoporous silicon nanowires were mostly amorphous (FIG. 7C), with some dark particles 704 of less than 5 nm embedded in the amorphous matrix. SAED pattern 710 in FIG. 7D confirms that the particles 704 are crystalline silicon. This provides evidence that lithiation and delithiation in silicon is not homogenous, therefore contributing to non-uniform stress distribution even at low charge/discharge rate. At some locations, accumulated stress may be large enough to break silicon into fragments. This is especially true for non-porous structures, like nonporous silicon nanowires which are not able to sustain capacity after long cycling, since lithium ions can only intercalate into silicon from the very outer surface and generate a large concentration gradient from surface to inner core, thus inducing large stress.

### Example 2

### Nanoporous Silicon from Bulk Silicon

Nanoporous silicon particles, including nanoporous silicon nanoparticles, were prepared from bulk sized, boron-doped silicon with proper doping level (resistivity<20 mΩ·cm). In other examples, the dopant could be iron, chromium, phosphorus, arsenic, aluminum, or a combination thereof. The bulk sized silicon was crushed down to small pieces with a size around or less than 5 mm. This small sized silicon was further treated by one of several methods.

In a first method, the small sized silicon was milled to fine powder using ball milling until a size of about 1 micron was achieved. In a second method, the small sized silicon was milled to fine powder using ball milling until the size was less than 1 micron (e.g., around 200 nm or around 100 nm). In a third method, the small sized silicon was further milled to a fine powder using ball milling until the size was around 200 nm. These fine particles were mixed with boric acid with mass ratio from Si:H₃BO₃=5:(0.5-10). The mixing procedure can either be direct dry mixing, or wet mixing by dissolving silicon fine particles and H₃BO₃ into H₂O; and then well mixed and dried to yield a mixed powder. The mixed powder was heated to a temperature above 800° C. for 0.5-3 hours in an argon protected environment, then cooled down to room temperature.

The prepared silicon particles were etched as follows. Silicon fine particles were washed with diluted HF solution (1%-2%) to remove the silicon oxide layer generated during the crunching and milling procedure; then these particles were washed with H₂O and dried to yield a powder, and transferred to a plastic container. An etchant solution containing HF and AgNO₃ or HF and Fe(NO₃)₃ was prepared, and then poured into the plastic container with the dry fine silicon particles (powder). The particles were stirred for several minutes, and then kept static for several hours to yield nanoporous silicon particles. After etching, nanoporous silicon particles were washed with H₂O, HNO₃ solution, and H₂O sequentially, and then dried to yield nanoporous silicon powder. Etchant solutions of differing concentrations containing 1-10 M HF and 5-100 mM AgNO₃ were used to change the porosity and pore size of nanoporous silicon.

### Example 3

### Lithium Ion Battery Electrodes with Nanoporous Silicon Particles

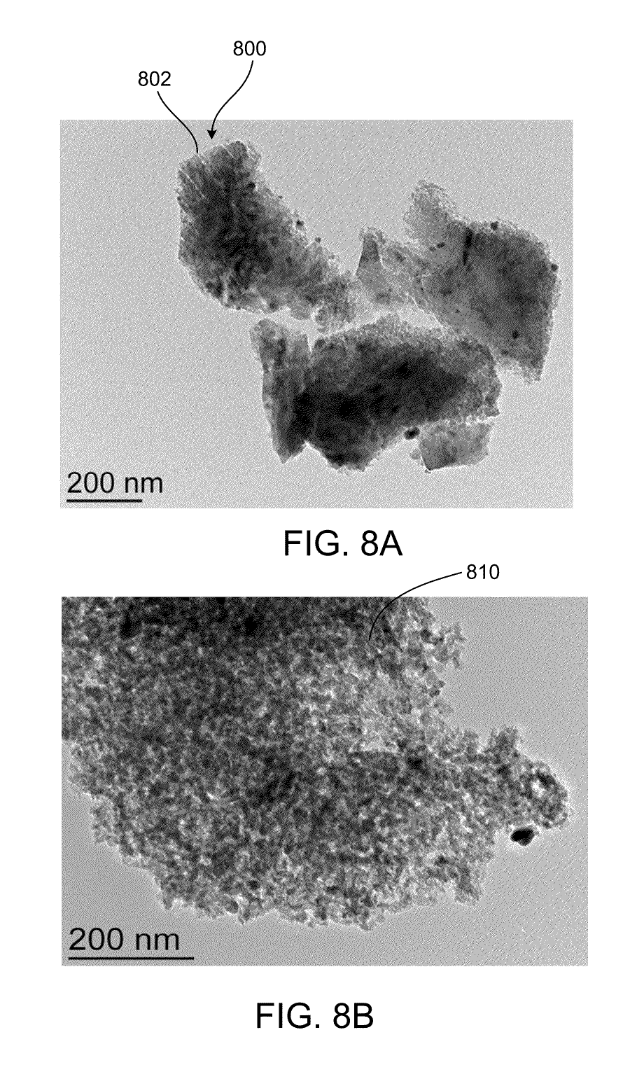

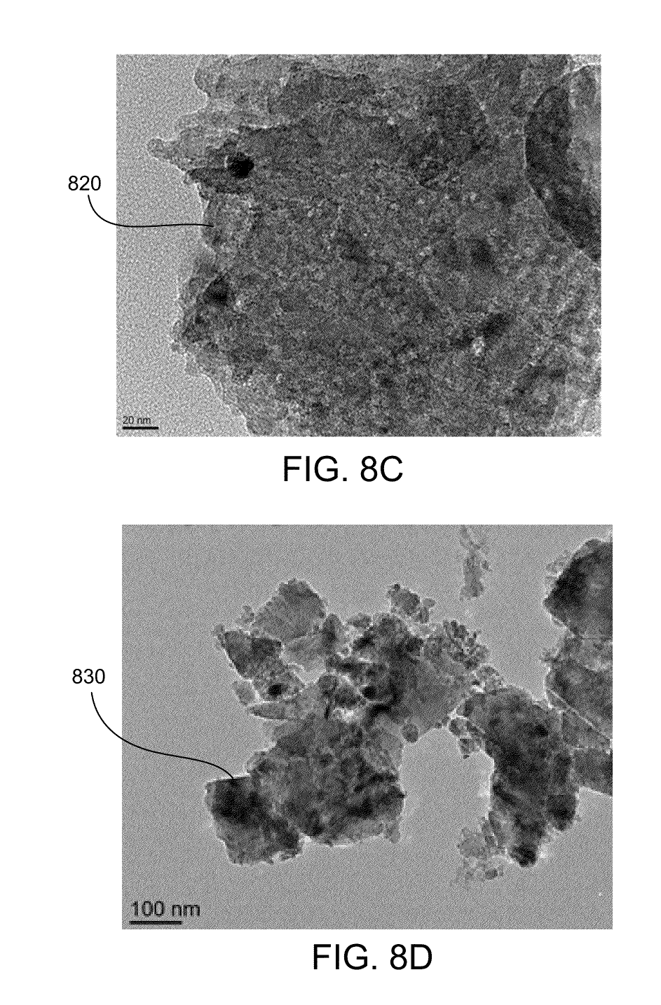

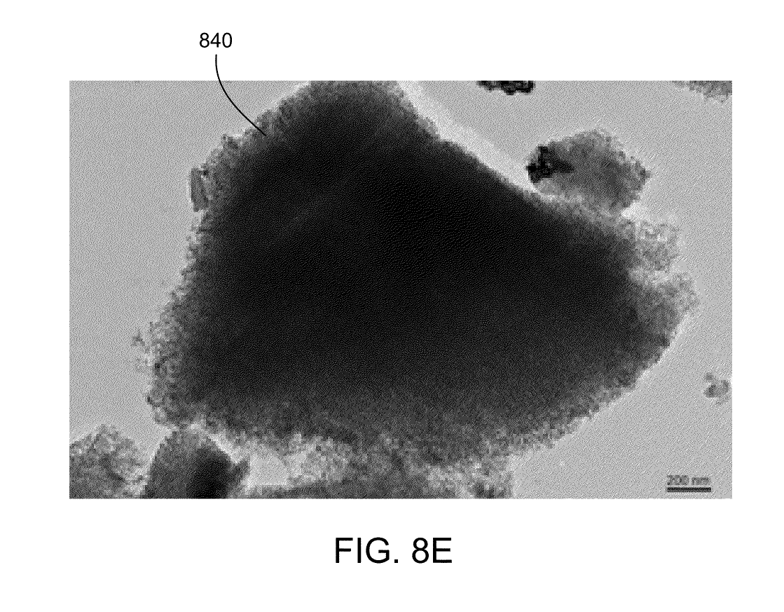

Metallurgical grade silicon (˜99%) was used as received without further purification to remove common impurities (e.g., Fe, Al). To produce nanoporous silicon structures, the silicon was milled into to small particles (e.g., several to tens of micrometers) using wet ball mill technology. Ethanol or other non-oxidant solvents can be used as additive in the ball mill process. The mass ratio of silicon:ball:additive is typically around 1:5:1, but other ratios can be used as well. As obtained, microsized silicon was collected and washed with diluted hydrofluoric acid (HF, 1-5 wt %) to remove oxide on the surface of the particles. The silicon particles were immersed into etchant solution containing AgNO₃ and HF, and kept static for about 2 hours to yield nanoporous silicon particles. In one example, the concentration of AgNO₃ and HF was 20 mM and 5 M in the etchant solution, respectively. The nanoporous silicon particles were washed with de-ionized water (DI-H₂O), concentrated nitric acid (HNO₃) and DI-H₂O to remove Ag particles (e.g., excess Ag particles) generated in the etching process. FIG. 8A shows a typical TEM image of nanoporous silicon particles 800 formed as described herein, with pores 802 visible at the edges and surfaces of the silicon particles.

To further increase the porosity, a second etching step was employed. An etchant solution containing 5 M HF and 0.12 M hydrogen peroxide (H₂O₂) was prepared. A small amount of ethanol was added to increase the wettability to silicon. Other solvents, such as methanol or isopropanol, may also be used. Nanoporous silicon formed as described above (e.g., without washing with HNO₃) were immersed in the etchant solution and kept static for about 2 hours, and washed by DI-H₂O and dried to yield powder. FIG. 8B shows a TEM image of nanoporous silicon particles 810 after this second etching step. Brunauer-Emmett-Teller (BET) tests indicate that the nanoporous silicon particles have a surface area of 63 m²/g.

FIG. 8C shows a TEM image of nanoporous silicon particles 820 formed from metallurgical grade silicon after etching with Fe(NO₃)₃ and HF. FIG. 8D shows a TEM image of nanoporous silicon particles 830 formed from metallurgical grade silicon after etching with Cu(NO₃)₂ and HF. FIG. 8E shows a TEM image of nanoporous silicon particles 840 formed from metallurgical grade silicon after etching with HAuCl₄ and HF.

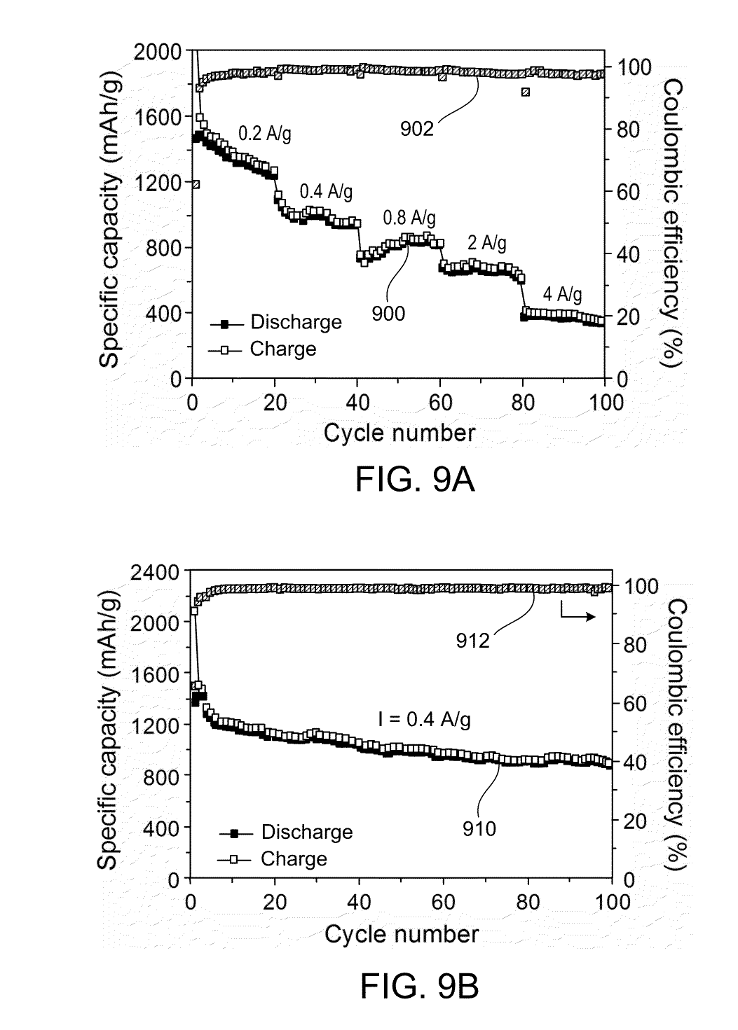

FIG. 9A shows the electrochemical performance of a nanoporous silicon anode at charge/discharge rates ranging from 0.2 A/g to 4 A/g, with plot 900 showing overlapping charge and discharge, and plot 902 showing Coulombic efficiency. FIG. 9B shows the cycling performance of a nanoporous silicon anode at a current rate of 0.4 A/g for 100 cycles, with plots 910 showing overlapping charge and discharge, and plot 912 showing Coulombic efficiency. The capacity remained above 1000 mAh/g for 100 cycles.

### Example 4

### Nanoporous Silicon Nanoparticles from Silicon Nanoparticles

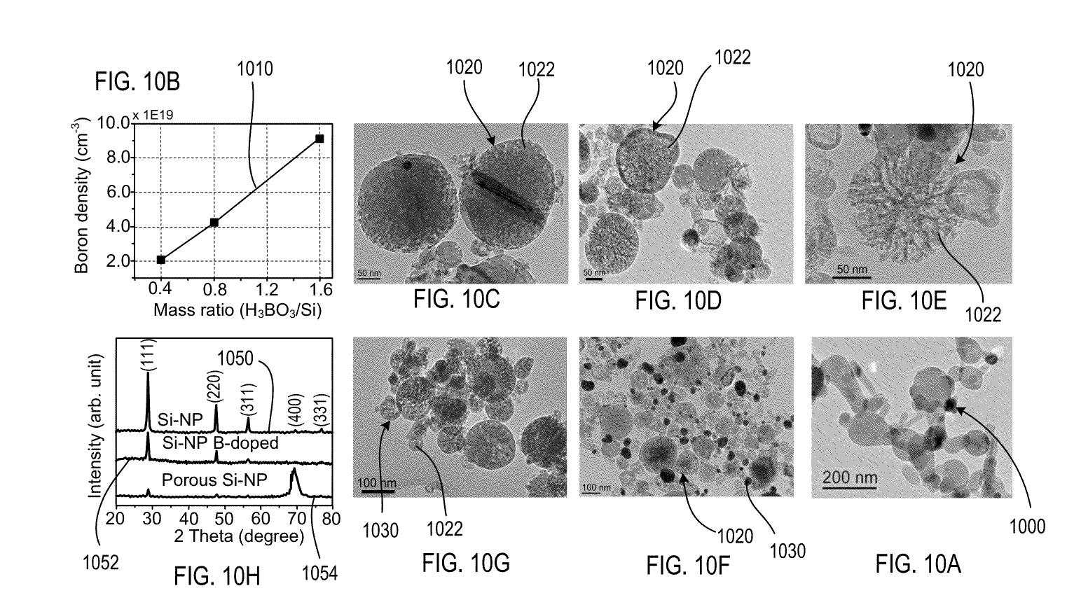

Nanoporous silicon nanoparticles are prepared as described with respect to FIG. 4. Silicon nanoparticles with mean size around 100 nm (e.g., between 50 nm and 500 nm) were mixed with boric acid, and then annealed at 1050° C. in an argon protected environment for 3 hours to yield boron-doped silicon nanoparticles. The product was washed with hydrofluoric acid (HF) to remove by-products (e.g., B₂O₃ and SiO₂), and further washed with de-ionized water 3 times then dried to yield a powder. FIG. 10A shows a TEM image of silicon nanoparticles 1000 before etching.

An etchant solution containing 20 mM silver nitrite (AgNO₃) and 5 M HF was prepared, and the boron-doped silicon nanoparticles were immersed in the etchant solution under mild stirring. During the reaction, bubbles appeared as an indication of etching. After one hour, the reaction was stopped by adding more DI-H₂O, and the mixture was centrifuged at 8000 rpm for 10 minutes; 3 times of additional washing using DI-H₂O were employed. Plot 1010 in FIG. 10B shows a linear relationship between final boron doping densities and the mass ratio of boric acid to silicon nanoparticles, with selected mass ratios of 0.4, 0.8, and 1.6.

FIGS. 10C-10G show TEM images of nanoporous silicon nanoparticles 1020 after etching. Pores 1022 appear to be fairly evenly distributed over nanoparticles 1020. Pores 1022 have a mean diameter of about 10 nm (e.g., between 5 nm and 20 nm). FIGS. 10C-10E correspond doped silicon nanoparticles with the initial mass ratio of boric acid to silicon nanoparticles of 0.4, 0.8, and 1.6, respectively. As seen in FIGS. 10C-E, a higher doping density yields a rougher surface, or larger pores 1022 in nanoparticles 1020.

FIG. 10F shows silver particles 1030 present after etching. It can be seen that silver particles 1030 are larger than pores 1022, which indicates a dynamic process silver cluster formation via Ag⁺ [symbol] Ag (small cluster) that contributes to the pore etching. The large silver particles may result from a nucleation and growth mechanism of silver, but may not participate in the etching process. FIG. 10G shows silicon nanoparticles 1020 after the particles are washed with H₂O and the remaining Ag dissolved with nitric acid (HNO₃).

X-ray diffraction patterns were recorded at different experimental stages to examine the crystallography properties of the sample. As shown in plot 1050 of FIG. 10H, silicon nanoparticles before etching show isotropic diffraction. Plot 1052 shows a single silicon phase is revealed without any other Si—B compounds after boron doping, demonstrating that boron has been successfully doped into silicon, instead of forming Si—B alloy (B₆S₁, B₃Si, etc.). However, after etching, the XRD pattern in plot 1054 shows that the relative intensity ratios of (400) over other planes are larger than the standard values in the JCPDS card (no. 27-1402), indicating preferential preserving of {100} planes, which is the result of anisotropic etching of Ag⁺ along silicon <100> direction.

Detailed analysis of the peak broadening using the Scherrer equation indicates the coherence length of Dₕₖₗ of (400) is about 26 nm, which is apparently smaller than the particle size (around 100 nm). This small coherence length of (400) evinces again the existence of pores on silicon nanoparticle {100} surface.

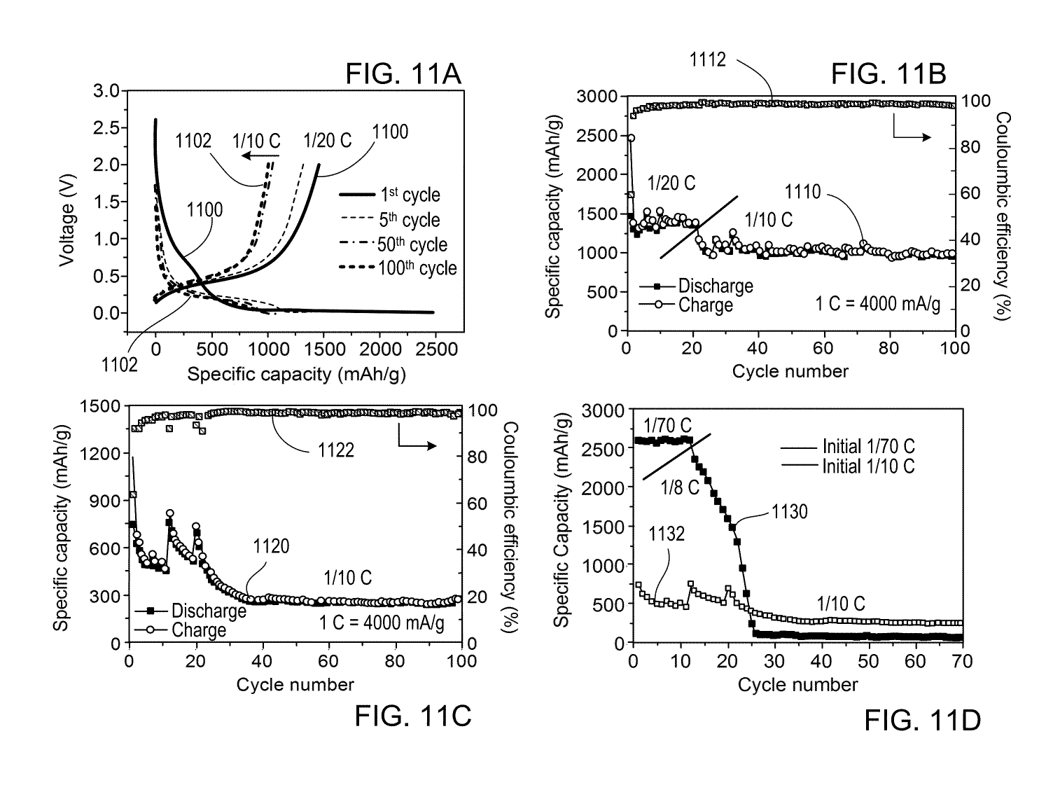

Coin cells using lithium metal as a counter electrode were employed to evaluate the electrochemical performance of nanoporous silicon nanoparticles (carbon coated). The electrode was fabricated with 3:1 (mass ratio) of nanoporous silicon nanoparticles and carbon black, and 15 wt % of alginic acid sodium salt as the binder (2 wt %, viscosity ˜2000 cP at room temperature). FIG. 11A shows the discharge-charge voltage profile cycled at 1/20 C and 1/10 C (1 C=4000 mA/g) over the voltage window 0.01-2.0 V vs. Li⁺/Li. The 1^{st} cycle at current rate of 1/20 C (0.2 A/g), shown by plots 1100, shows charge and discharge capacities of 2469 mAh/g and 1464 mAh/g, respectively; the low initial Coulombic efficiency (59.3%) was attributed to the formation of solid electrolyte interphase (SEI).

After 20 cycles, the current rate was increased 0.1 C (0.4 A/g), and the profiles for the 50^{th} and 100^{th} cycle were recorded. Plot 1102 represents the 100^{th} cycle. It was found that the capacity degradation is very small up to 100 cycles (FIG. 11B); the overlapping charge and discharge capacity, shown by plot 1110, remains above 1000 mAh/g, which accounts ˜70% of the second cycle. The Coulombic efficiency is shown by plot 1112. The performance is superior to that of silicon nanoparticles without etching (even carbon coated), in which the capacity drops to less than 300 mAh/g at current rate of 0.1 C, as shown in FIG. 11C by plot 1120. The Coulombic efficiency is shown by plot 1122.

Plots 1130 and 1132 in FIG. 11D show the cycling performance of solid silicon nanoparticles (carbon coated) at an initial current rate of 1/70 C and 1/10 C, respectively. At 1/70 C, the silicon nanoparticles show high and stable capacity (>2500 mAh/g), which may be due to the small size of silicon nanoparticles (<100 nm) that inhibit pulverization of the particles during cycling. However, the capacity degrades to a value less than 200 mAh/g if current is increased (to 1/8 C) or if the initial charge rate is increased (1/10 C), which is in contrast to the behavior of nanoporous silicon nanoparticles (FIG. 11B). This again illustrates the merits of the nanoporous nanostructures.

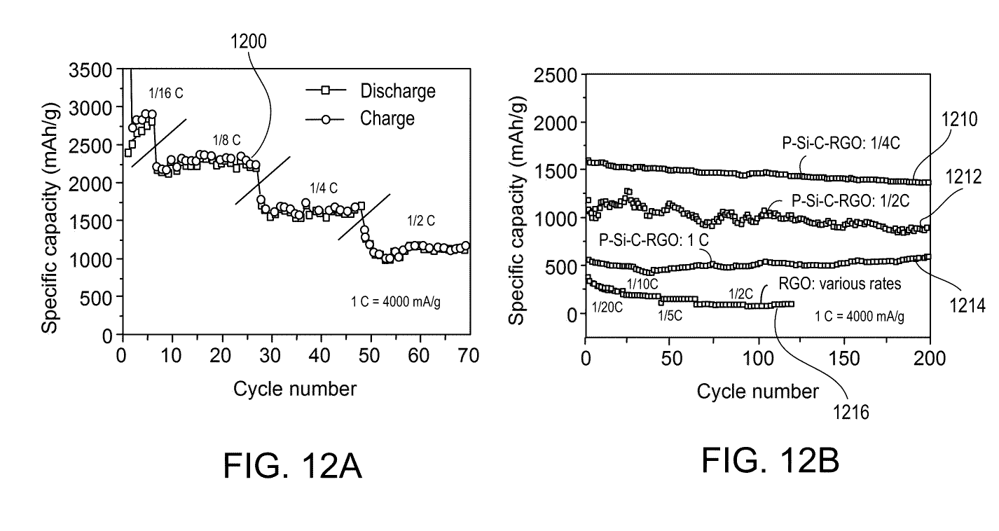

The electrochemical performance was further improved by wrapping carbon coated nanoporous silicon nanoparticles with reduced graphene oxide (RGO). FIG. 12A shows the capacity of nanoporous silicon nanoparticles with RGO at different current rates. Plot 1200 shows that capacity remains above 2500, 2200, 1500 and 1000 mAh/g at current rates of 1/16 C, 1/8 C, 1/4 C, and 1/2 C, respectively; and total mass of nanoporous silicon nanoparticles with RGO is accounted for in calculating specific capacity. Plots 1210, 1212, and 1214 in FIG. 12B shows cycle performance of nanoporous silicon nanoparticles with RGO (and carbon coating) at 1/4 C, 1/2 C, and 1 C, respectively, to demonstrate high rate and long cycle capacity retention; the capacity remains around 1500, 1000, and 600 mAh/g after 200 cycles, respectively. Pristine RGO is also tested at various current rates and shows a capacity of less than 100 mAh/g in plot 1216. Thus, the improvement of electrochemical performance of nanoporous silicon nanoparticles with RGO may be attributed to some aspect of RGO other than the capacity contributed from RGO.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. An electrode for a lithium ion battery, the electrode comprising:
nanoporous silicon structures, each nanoporous silicon structure defining a multiplicity of pores;
a binder; and
a conductive substrate,
wherein the nanoporous silicon structures are mixed with the binder to form a composition, and the composition is adhered to the conductive substrate to form the electrode.

2. The electrode of claim 1, wherein the nanoporous silicon structures are nanoporous silicon nanowires.

3. The electrode of claim 1, wherein the nanoporous silicon structures are nanoporous silicon particles having a mean diameter of 10 μm or less, between 1 μm and 10 μm, between 1 and 100 nm, between 50 and 150 nm, or between 50 and 500 nm.

4. The electrode of claim 3, wherein the nanoporous silicon structures are nanoporous silicon particles formed from powder silicon nanoparticles, bulk metallurgical grade silicon, or from silicon precursors through a plasma or chemical vapor deposition process.

5. The electrode of claim 1, further comprising carbon black, wherein the carbon black is mixed with the nanoporous silicon structures and the binder to form the composition.

6. The electrode of claim 1, wherein a mean diameter of the pores in the nanoporous silicon structures is in a range between 1 nm and 200 nm, and a distance between adjacent pores in the nanoporous silicon structures is in a range between 1 nm and 200 nm.

7. The electrode of claim 1, wherein the nanoporous silicon structures are coated with carbon, reduced graphene oxide, or a combination thereof.

8. The electrode of claim 1, wherein the nanoporous silicon structures are doped with boron, arsenic, phosphorus, iron, chromium, aluminum, or a combination thereof.

9. The electrode of claim 1, wherein the viscosity of the binder is in a range between 100 cP to 2000 cP at room temperature.

10. The electrode of claim 9, wherein the binder comprises an alginic acid salt.

11. The electrode of claim 1, wherein the specific capacity of the electrode exceeds 1000 mAh/g after 100 cycles at a charge/discharge rate of 0.4 A/g.

12. A lithium ion battery comprising the electrode of claim 1.

13. A method comprising:
combining nanoporous silicon structures, each nanoporous silicon structure defining a multiplicity of pores, with a binder to form a mixture; and
forming the mixture to yield an electrode for a lithium ion battery, wherein the specific capacity of the electrode exceeds 1000 mAh/g after 100 cycles at a charge/discharge rate of 0.4 A/g electrode.

14. The method of claim 13, further comprising:
etching solid silicon structures with a first etchant solution comprising a metal salt and strong acid to yield the nanoporous silicon structures before combining the nanoporous silicon structures with the binder; or
etching solid silicon structures with a first etchant solution comprising a metal salt and strong acid to yield the nanoporous silicon structures and then etching the nanoporous silicon structures with a second etchant solution comprising a strong acid and an oxidizing agent before combining the nanoporous silicon structures with the binder.

15. The method of claim 14, wherein the solid silicon structures are selected from the group consisting of silicon wafers, silicon nanoparticles, metallurgical grade silicon particles, and silicon particles prepared from silicon precursors in a plasma or chemical vapor deposition process.

16. The method of claim 14, wherein the solid silicon structures are metallurgical grade silicon particles having a purity of at least 95% and less than 99.9%, less than 99.8%, less than 99.5%, less than 99%, less than 98%, or less than 96%, and further comprising ball-milling the metallurgical grade silicon particles before etching the solid silicon structures.

17. The method of claim 14, wherein the solid silicon structures are doped with boron, arsenic, phosphorus, iron, chromium, aluminum, or a combination thereof.

18. The method of claim 14, wherein the metal salt is silver nitrate.

19. The method of claim 18, wherein the metal salt comprises iron nitrate, chloroauric acid, copper nitrate, copper chloride, cobalt (III) nitrate, cobalt (III) chloride, or a combination thereof.

20. The method of claim 13, further comprising:
coating the nanoporous silicon structures with carbon by decomposition of a carbon-containing compound before combining the nanoporous silicon structures with the binder; or
coating the nanoporous silicon structures with carbon by decomposition of a carbon-containing compound before combining the nanoporous silicon structures with the binder, and coating the carbon-coated nanoporous silicon structures with reduced graphene oxide before combining the nanoporous silicon structures with the binder.
